(19) United States
(12) Patent Application Publication
(10) Pub. No.: US 2003/0197378 A1
(43) Pub. Date: Oct. 23, 2003

(54) Sealing compression ferrule for plumbing connection fitting

(76) Inventors: Bradley E. Allstead, Trenton, MI (US); Robert O. Learmont, Howell, MI (US); Donald S. Glover, Birmingham, MI (US)

Correspondence Address: Edgar A. Zarins, Masco Corporation, 21001 Van Born Road, Taylor, MI, 48180, US

(21) Appl. No.: 10/315,606

(22) Filed: Dec. 10, 2002

Related U.S. Application Data
(60) Provisional application No. 60/373,538, filed on Apr. 18, 2002.

(51) Int. Cl. F16L 17/00

(52) U.S. Cl. 285/341

(57) ABSTRACT

A compression connector for sealingly connecting a fluid line to a plumbing fitting, valve or connector. The connector assembly sealingly retains the tubing within the device to direct flow therethrough. The plumbing fitting includes a seat for matingly receiving the tubing in fluid communication with the interior passageways of the fitting. With the tubing seated in the fitting, a compression ferrule and a compression nut are coaxially mounted to the tubing. The compression ferrule includes wedge-like edges at both the leading and trailing ends thereof. The compression nut has an angled shoulder configured to engage the trailing edge of the ferrule. As the nut is rotated onto the fitting, the angled shoulder deflects the trailing edge of the ferrule radially inwardly into engagement with the tubing. Similarly, the leading edge of the ferrule is deflected radially inwardly into engagement with the tubing. The dual deflection edges create a sealing connection of the tubing within the fitting.

### RELATED APPLICATIONS

This application claims priority from U.S. Provisional Application No. 60/373,538 filed on Apr. 18, 2002.

### BACKGROUND OF THE INVENTION

I. Field of the Invention

The present invention is directed to a compression fitting for connecting sections of fluid tubing to valves, connectors or additional lengths of tubing and, in particular, to a compression fitting with multiple sealing points to improve sealing connection of the components.

II. Description of the Prior Art

Compression fittings have become a convenient device for connecting valves, splitters, connectors and new fluid lines without the need for specialized tools. With the increased utilization of flexible plastic material such as PEX and CPVC in plumbing fluid lines, compression couplings permit the do-it-yourselfer to run new plumbing or to repair existing lines. Traditionally, copper or other metal tubing was used to deliver water to a desired fixture. Copper is often sweat together or to fittings, which is an art in itself. Compression couplings eliminate the need for specialized tools or skills.

The prior known compression couplings generally included a body with a seat corresponding to the outer diameter of the pipe being used. The pipe is inserted into the seat to provide fluid communication with the throughbore of the coupling body. A compression nut and compression ring, each having an axial throughbore, are coaxially mounted to the tubing. The compression nut is adapted to threadably engage the coupling body simultaneously placing the ring into compression against the tubing. This compressive engagement is intended to both seal against the outer surface of the tubing while gripping the tubing to prevent the pipe from backing out of its seat.

The limitations of the conventional compression coupling can cause improper installation and possible fluid leakage. Often the compression rings do not adequately retain the tubing in position as the nut is tightened. Still another disadvantage is that the compression rings may not function properly if the ring alignment is poor, can be deformed if the fitting is overtightened or the improper tools are used. Due to the nature of different tubing material properties, i.e. copper, PEX and CPVC, each type of tubing has had its own system of securing and sealing within the respective fitting. Additionally, fittings must accommodate copper tubing with different wall thicknesses and tempers. It is desirable to have an inexpensive coupling assembly which is easily installed and assures that the tubing when secured therein has a reduced possibility of leakage.

### SUMMARY OF THE PRESENT INVENTION

The present invention overcomes the disadvantages of the prior known compression fittings by utilizing internal geometry to ensure a secure gripping action and improved sealing to prevent leakage through the fitting.

A compression fitting according to the present invention may be utilized in conjunction with a variety of plumbing assemblies to connect a water line to the assembly. Some examples of such plumbing assemblies include valves, connectors, diverters or tees, and faucets. The plumbing assembly will include a body having at least one pocket having an inner diameter closely corresponding to the outer diameter of the fluid tubing to be used therewith. The pocket may include an end wall against which the end of the tubing can abut. The end wall includes a throughbore to direct fluid from the tubing through the plumbing assembly. An exterior surface of the assembly includes threads for threadably engaging a compression nut. The compression nut has a throughbore for receiving the fluid tubing and preferably a hex exterior for manipulation on the assembly.

The compression connector of the present invention employs a uniquely configured ferrule or compression ring to create a secure sealing engagement and retain the tubing within the fitting. The ferrule has a substantially annular configuration with an intermediate portion having a substantially uniform thickness. The interior and exterior ends of the ferrule taper in thickness from the intermediate portion forming wedge-like edges. An inner surface of the ferrule includes annular grooves coaxial with the wedge-like outer surfaces of the ferrule. These annular grooves will form deflection joints allowing the edges of the ferrule to bend inwardly under compression.

The inner surface of the compression nut includes a shoulder intended to act upon the exterior end of the ferrule during tightening. The shoulder may be provided with any well-known geometry capable of deflecting the end of the ferrule into the tubing. Similarly, the fitting includes a leading edge to engage the interior end of the ferrule during tightening. The present invention requires fewer rotations for sealing the fitting than has been required by the prior known connectors thereby accelerating the sealing compression. As the compression nut is tightened, the angled shoulder will engage the exterior end of the ferrule and deflect the edge radially inwardly into engagement with the tubing. Subsequently but nearly simultaneously, the interior end of the ferrule will be deflected inwardly into sealing engagement with the tubing. In this manner, the tubing is sealingly seated within the fitting. The ferrule will bend along the deflection ring formed by the annular grooves. The cooperation of the shoulder within the compression nut and the slope of the ferrule is calculated to deflect the exterior end of the ferrule prior to deflection of the interior end. Nevertheless, the internal geometry may be configured to deflect both ends of the ferrule substantially simultaneously.

In order to provide secondary sealing capability, the compression nut in these embodiments of the compression coupling includes a captured O-ring to seal against the exterior of the fluid line. An annular groove is formed within the inner surface of the compression nut proximate the head or exterior end of the compression nut. A seal member is positioned within the groove to extend partially into the throughbore of the compression nut. In this manner, fluid tubing passing through the compression nut into the fitting will be sealingly engaged by the O-ring. The primary seal is formed between the tubing, ferrule and the ferrule pocket and the O-ring engaging the tubing acts as the secondary seal for the compression coupling of the present invention.

The compression coupling of the present invention is designed to secure copper of various thicknesses and tempers, PEX or CPVC tubing to an industry standard compression fitting or valve. The coupling is preferably delivered to the end user fully assembled and hand tightened to the fitting or valve body. The user will slip the tubing through the compression nut and ring without having to align the ring into the seat passing through the O-ring seal. The end user can then simply tighten the nut to adequately secure the tubing. The coupling is engineered to collapse the ferrule around the tubing providing a primary seal. In certain embodiments, the O-ring provides a secondary seal should the primary compression ring seal fail due to expected dimensional changes to the tubing from thermal expansion, compression set, creep, etc.

Other objects, features and advantages of the invention will be apparent from the following detailed description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the view and in which:

FIG. 1 is a cross-sectional view of a plumbing fitting incorporating the compression connector embodying the present invention;

FIG. 2 is a cross-sectional view thereof;

FIG. 3 is a cross-sectional view of an alternative configuration thereof;

FIG. 4 is a cross-sectional view of the compression nut;

FIG. 5 is a partial cross-sectional of the ferrule; and

FIG. 6 is a cut-away view of the ferrule.

### DETAILED DESCRIPTION OF A PREFERRED EMBODIMENT OF THE PRESENT INVENTION

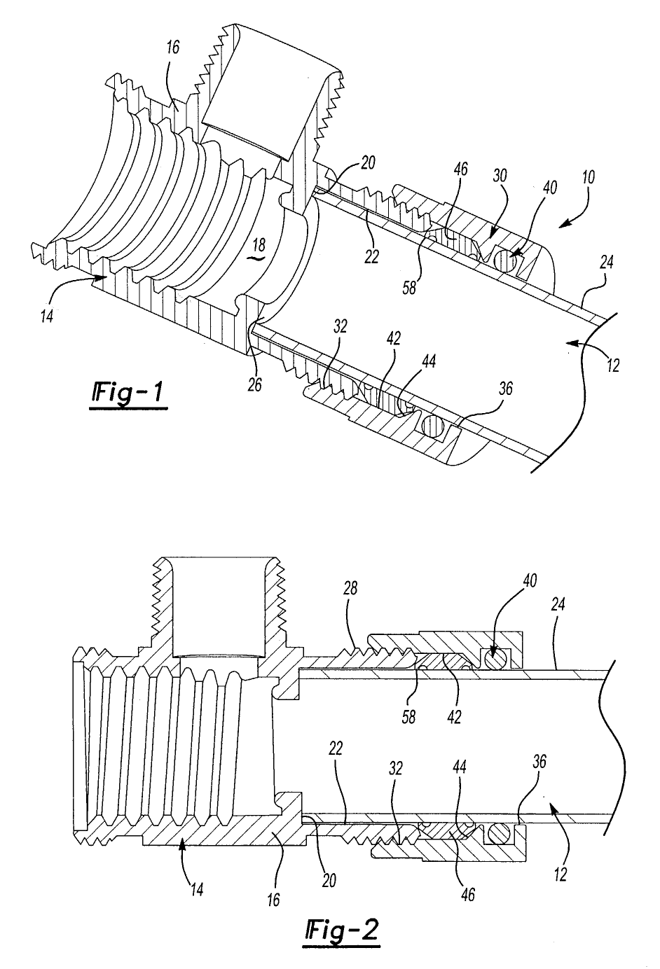

Referring first to FIGS. 1 and 2, cross-sectional views of a plumbing connection 10 embodying the present invention is shown. The plumbing connection 10 is designed to direct fluid flow from a fluid line 12 through a fitting 14. The fitting 14 is provided for illustrative purposes only and the connection assembly can be utilized with a variety of devices such as valves, connectors and similar fittings. The connection assembly 10 of the present invention is an improvement over the conventional compression fitting which allows the user to connect plumbing devices within a plumbing line 12 without the need for specialized tools or adhesives. The present invention provides improved sealing capabilities within the connection assembly 10 with a minimum of rotational torque as will be subsequently described.

The fitting 14 includes a body 16 with at least one passageway 18 through which fluid flow may be directed. Formed in fluid communication with the passageway 18 is a pocket 20 for receiving the fluid line 12 to direct flow between the fluid line 12 and the passageway 18. The pocket 20 has an inner diameter 22 conforming closely with the outer diameter 24 of the tubing 12 so as to matingly receive the fluid line 12. An end wall 26 of the pocket 20 limits the insertion of the tubing 12 into the fitting 14. An exterior surface of the fitting 14 coaxial with the pocket 20 includes threads 28 to facilitate assembly as will be subsequently described.

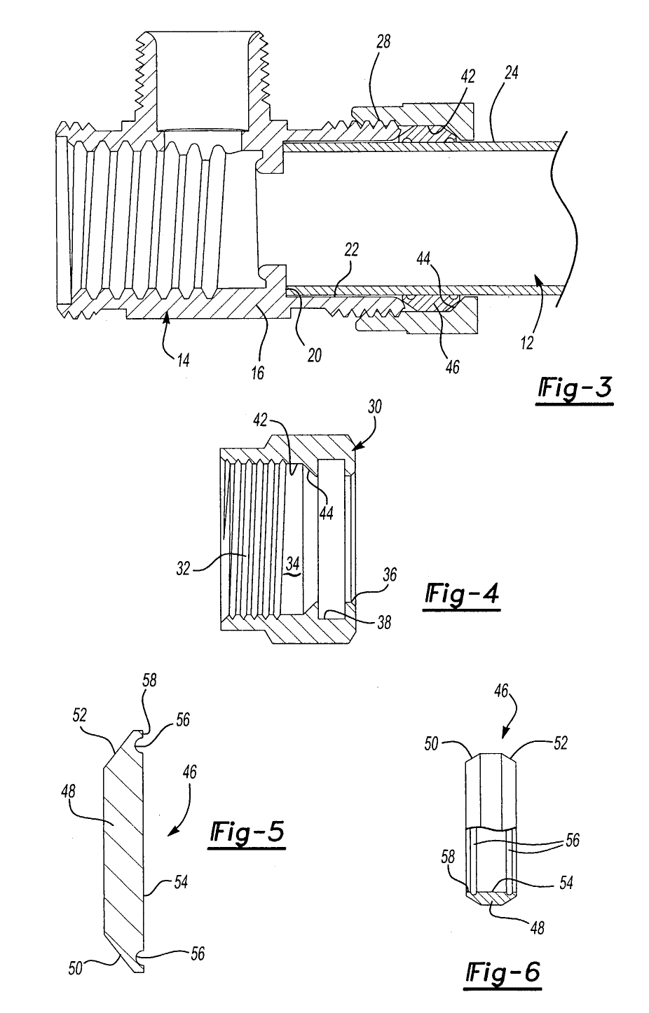

A nut 30 includes inner threaded surface 32 for threadably mounting the nut 30 to the fitting 14. The nut 30 includes a throughbore 34 with an aperture 36 conforming to the outer diameter 24 of the tubing 12 so as to coaxially mount to the tubing 12. In one embodiment of the nut 30, an annular groove 38 is formed in the inner surface of the nut 30 proximate the exterior end of the nut 30. A seal member 40 is positionally captured within the groove 38 for sealing engagement with the exterior 24 of the tubing 12 extending through the nut 30. FIG. 3 depicts the connection 10 of the present invention without an annular groove in the nut 30.

Formed longitudinally inward from the aperture 36 of the nut 30 is an annular recess 42 of larger diameter within the nut 30. The recess 42 is defined at one end by a sloped shoulder 44 having a predetermined angle in order to set the compression connection properly. In a preferred embodiment, the shoulder 44 has an angle of 45°(±5°). Received within the recess 42 of the nut 30 is a compression ring or ferrule 46 through which the tubing 12 passes. The ferrule 46 has an inner diameter which closely conforms to the outer diameter of the tubing 12. The ferrule 46 lockingly engages the tubing 12 upon compression of the nut 30 as will be described.

As best shown in FIGS. 5 and 6, the ferrule 46 consists of an intermediate portion 48 of substantially uniform thickness, a leading end 50 tapering in thickness, and a trailing end 52 tapering in thickness. The leading and trailing ends 50,52 of the ferrule 46 form wedge-like configurations for the ferrule 46. As with the internal configuration of nut 30, the slope or angle of the leading and trailing ends 50,52 are calculated to cooperate with the nut 30 so as to create the desired setting forces. In a preferred embodiment, the angle of the sloped ends 50,52 is 30°(±5°). The tapering ends 50,52 create flats 58 at both ends of the ferrule 46. In one embodiment of the invention, the end flats 58 are 0.020 to 0.040 inches in width to optimize gripping engagement with the tubing 12. Formed on the inner surface 54 of the ferrule 46 is at least one annular groove 56. The annular groove 56 is formed coaxial with the corresponding sloped end 50,52 and acts as a deflection joint as the ferrule is placed under compressive pressure. The number or depth of the grooves 56 may be altered in order to obtain varying deflection of the ends 50,52 of the ferrule 46.

Operation of the compression connection 10 of the present invention facilitates sealing retention of the fluid tubing 12 within the connector. The entire connector 10 can be supplied to the user preassembled with the ferrule 46 disposed within the nut 30 and the nut 30 threadably mounted to the fitting 14. Since the ferrule 46 is captured within the nut 30, the tubing 12, is inserted through the aperture 36 of the compression nut 30 and into the pocket 20. Unlike the prior known compression fittings and certain tubing materials, the connector 10 of the present invention can be set in an accelerated fashion with fewer rotations of the fastener nut 30.

As the nut 30 of the present invention is rotated, the sloped shoulder 44 of the nut 30 comes into engagement with the trailing edge 52 of the ferrule 46. Since the ferrule is captured and prevented from moving longitudinally, the sloped shoulder 44 will begin to deflect the trailing edge 52 radially inwardly into the tubing 12. Subsequently but almost simultaneously, the leading edge 50 of the ferrule 46 will engage the fitting 14 and deflect radially inwardly into engagement with the tubing 12. Both edges 50,52 will deflect about the annular grooves 56 formed in the ferrule 46. As the trailing edge 52 is deflected and grabs the tubing 12, continued rotation of the nut 30 will tend to push the ferrule 46 and therefore the tubing 12 towards the fitting and into the pocket 20 until the leading edge 50 of the ferrule 46 is set. Thus, the dual edges 50,52 of the ferrule 46 form dual sealing points along the tubing 12. The geometrical configuration of the sloped shoulder 44, the slope of the edges 50,52 and the positioning and depth and width of the grooves 56 of the ferrule 46 can all be altered to alter the deflection properties of the ferrule 46 for various materials and constructions. In fact, various aspects of the ferule 46 can be adjusted to create different sealing properties for different material combinations and applications. The end flats 58 can be narrowed or widened to alter deflection. The shape of the grooves 56 can be altered from a semicircular shape to square, rectangle, V-shaped, etc. The width of the grooves 56 can also be altered to vary the deflection properties.

The compression coupling of the present invention is designed to secure copper, PEX or CPVC tubing to a common compression fitting or valve. The coupling is delivered to the end user fully assembled and hand tightened to the fitting or valve body. The user will slip the tubing through the compression nut and ring into the pocket passing through the O-ring seal. The end user can then simply tighten the nut to provide adequate retention of the tubing. The coupling is engineered to deflect both ends of the compression ring to collapse around the tubing and provide a reliable seal. The O-ring provides a secondary seal should the primary compression ring seal fail due to dimensional changes to the tubing. As is shown in FIG. 3, the compression fitting of the present invention can be be constructed without the secondary O-ring seal relying on the seal created by crimping the ferrule 46 against the tubing 12 within the pocket 20.

The foregoing detailed description has been given for clearness of understanding and no unnecessary limitations should be understood therefrom as some modifications will be obvious to those skilled in the art without departing from the scope and spirit of the appended claims.

What is claimed is:

1. A fluid line coupling comprising:
a fluid device having a body with an internal fluid passageway and a pocket in communication with said fluid passageway, said pocket sized to receive the fluid line;
a fastener member threadably engaging said fluid device, said fastener member having a throughbore forming an inner surface sized to receive the fluid line; and
a primary sealing member made from a deformable material, said primary sealing member sized to receive the fluid line and said primary sealing member disposed within said body of said fluid device wherein upon tightening of said fastener member said primary sealing member is deformed radially inwardly to engage the fluid line at spaced apart annular regions of the fluid line.

2. The coupling as defined in claim 1 wherein said primary sealing member is an annular ferrule positioned within said body of said fluid device, said annular ferrule having an inner surface conforming substantially to an outer surface of the fluid line, the fluid line extending through said ferrule positioned within said fluid device, said ferrule selectively deformable to engage the fluid line.

3. The coupling as defined in claim 2 wherein said annular ferrule has a cross-sectional configuration which includes an intermediate portion and first and second sloped ends tapering downwardly from opposite sides of said intermediate portion.

4. The coupling as defined in claim 3 wherein said annular ferrule includes at least one annular groove formed in said inner surface of said ferrule.

5. The coupling as defined in claim 4 wherein said at least one annular groove is formed concentrically with one of said first and second sloped ends of said ferrule.

6. The coupling as defined in claim 4 wherein an annular groove is formed in said inner surface coaxially with each of said first and second sloped ends.

7. The coupling as defined in claim 6 wherein said annular grooves each have different configurations to alter the deflection properties of said first and second ends.

8. The coupling as defined in claim 2 and further comprising a secondary sealing member formed of an elastomeric seal captured within an annular groove formed in an inner surface of said fastener member.

9. The coupling as defined in claim 8 wherein said annular groove is formed proximate an exterior end of said fastener member distal from said fluid device.

10. The coupling as defined in claim 9 wherein said elastomeric seal is an O-ring positioned within said annular groove.

11. The coupling as defined in claim 7 wherein said fastener member includes an angled internal shoulder selectively engageable with said ferrule to deform said ferrule into sealing engagement with the fluid line.

12. A fluid line coupling comprising:
a fluid device having a body with an internal fluid passageway and a pocket in communication with said fluid passageway, said pocket sized to receive the fluid line;
a fastener member threadably engaging said fluid device, said fastener member having a throughbore forming an inner surface sized to receive the fluid line; and
a primary sealing member formed of a deformable material, said primary sealing member disposed within said body of said fluid device and sized to receive the fluid line, said primary sealing member having selectively deflectable ends wherein upon tightening of said fastener member said ends of said primary sealing member are deformed radially inwardly to engage the fluid line at spaced apart annular regions of the fluid line.

13. The coupling as defined in claim 12 wherein said primary sealing member is an annular ferrule positioned within said body of said fluid device, said annular ferrule having an inner surface conforming substantially to an outer surface of the fluid line, the fluid line extending through said ferrule positioned within said fluid device, said ferrule selectively deformable to engage the fluid line.

14. The coupling as defined in claim 13 wherein said annular ferrule has a cross-sectional configuration which includes an intermediate portion and first and second sloped ends tapering downwardly from opposite sides of said intermediate portion.

15. The coupling as defined in claim 14 wherein said annular ferrule includes at least one annular groove formed in said inner surface of said ferrule.

16. The coupling as defined in claim 15 wherein an annular groove is formed in said inner surface coaxially with each of said first and second sloped ends.

17. The coupling as defined in claim 16 wherein said annular grooves each have different configurations to alter the deflection properties of said first and second ends.

18. The coupling as defined in claim 14 wherein said annular ferrule includes end flats outboard of said annular grooves.
